(19) United States
(12) Patent Application Publication
(10) Pub. No.: US 2023/0319044 A1
(43) Pub. Date: Oct. 5, 2023

(54) LOGGING AND CONTROLLING COMMUNICATIONS USING UNIVERSAL REFERENCES FOR HARDWARE AND/OR SOFTWARE CONFIGURATIONS

(71) Applicant: Cisco Technology, Inc., San Jose, CA (US)

(72) Inventors: Edward A. Warnicke, Austin, TX (US); Jeffrey G. Schutt, Davis, CA (US); Eric A. Voit, Bethesda, MD (US)

(21) Appl. No.: 17/860,582

(22) Filed: Jul. 8, 2022

Related U.S. Application Data
(60) Provisional application No. 63/327,449, filed on Apr. 5, 2022.

(51) Int. Cl. H04L 9/40; G06F 9/54

(52) U.S. Cl. CPC H04L 63/101; G06F 9/547

(57) ABSTRACT

A method, computer system, and computer program product are provided for performing logging, securing communications, and performing digital forensics tasks based on universal references for hardware and/or software configurations. A universal reference, obtained by a first entity, is included in a request of a second entity, wherein the universal reference identifies one or more components of the second entity using additional universal references assigned to each of the one or more components. It is determined whether the first entity is authorized to receive data from the second entity based on the universal reference. Based on the determining, data is received from the second entity.

### CROSS REFERENCE TO RELATED APPLICATION

This application claims priority to U.S. Provisional Application No. 63/327,449, filed Apr. 5, 2022, entitled “LOGGING AND CONTROLLING COMMUNICATIONS USING UNIVERSAL REFERENCES FOR HARDWARE AND/OR SOFTWARE CONFIGURATIONS,” the entirety of which is incorporated herein by reference.

### TECHNICAL FIELD

The present disclosure relates to computing network security, and more specifically, to performing logging, securing communications, and performing digital forensics tasks based on universal references for hardware and/or software configurations.

### BACKGROUND

In the field of computing network security, attestation and digital forensics are important tools for the prevention of, or recovery from, security events such as unauthorized access, misuses, modification, or denial of a computer network or network-accessible resources. Attestation refers to a mechanism for computing devices to verify aspects of themselves (e.g., providing their identity, providing hardware or software components, etc.), with a goal of proving to a remote party that the operating system, software, and/or hardware is intact, free of vulnerabilities, and trustworthy. Computer forensics relates to the monitoring and analysis of computer functionality, network traffic, and the like, for the purposes of information gathering, collection of legal evidence, or intrusion detection.

When performing forensics or attestation tasks, knowledge about the contents of an executable software object is desired, but can be insufficient. In order to make fully informed decisions, network administrators would benefit from having additional details, such as the kernel of the system in which software is executing, the hardware state of the device upon which software is executing, the configuration of the running software, and additional details.

### BRIEF DESCRIPTION OF THE DRAWINGS

FIG. 1 is a block diagram depicting an environment for performing logging, securing communications, and/or performing digital forensics, in accordance with an example embodiment.

FIG. 2 is a tree diagram depicting a hierarchical description of a computing entity's artifacts, in accordance with an example embodiment.

FIG. 3 is a tree diagram depicting a hierarchical description of universal references for a computing entity's artifacts composed into bill of materials (BOM) objects, in accordance with an example embodiment.

FIG. 4 is a block diagram depicting a universal reference being generated based on an object, in accordance with an example embodiment.

FIG. 5 is a flow chart depicting a method for generating a universal reference, in accordance with an example embodiment.

FIG. 6 is a tree diagram depicting a hierarchical description of an executable file's artifacts, in accordance with an example embodiment

FIG. 7 is a sequence diagram depicting a communication between executables, in accordance with an example embodiment.

FIG. 8 is a flow diagram depicting a communication between executables and an authorizer, in accordance with an example embodiment.

FIG. 9 is a flow diagram depicting a communication between executables that is logged, in accordance with an example embodiment.

FIG. 10 is a flow diagram depicting a communication between executables using sidecars to offload operations, in accordance with an example embodiment.

FIG. 11 is a flow diagram depicting a communication between executables using sidecars and logging, in accordance with an example embodiment.

FIG. 12 is a flow diagram depicting the use of universal references to perform forensics, in accordance with an example embodiment.

FIG. 13 is a flow chart depicting a method for secured communication between applications using a universal reference, in accordance with an example embodiment.

FIG. 14 is a flow chart depicting a method for performing a forensics task using universal references, in accordance with an example embodiment.

FIG. 15 is a block diagram depicting a computing device configured to generate and/or utilize universal references, in accordance with an example embodiment.

### DESCRIPTION OF EXAMPLE EMBODIMENTS

### Overview

According to one embodiment, techniques are provided for performing logging, securing communications, and performing digital forensics tasks based on universal references for hardware and/or software configurations. A universal reference, obtained by a first entity, is included in a request of a second entity, wherein the universal reference identifies one or more components of the second entity using additional universal references assigned to each of the one or more components. It is determined whether the first entity is authorized to receive data from the second entity based on the universal reference. Based on the determining, data is received from the second entity.

### Example Embodiments

Embodiments are provided for performing computing and network security tasks, and more specifically, for performing logging, securing communications, and performing digital forensics tasks based on universal references for hardware and/or software configurations.

In the field of network security, network administrators seek to protect the integrity, confidentiality, and availability of computer networks, data, and devices using a variety of technologies. Inventory, or knowledge of a computing device's software and hardware configurations, can be extremely useful for security purposes, as individual components can be associated with specific vulnerabilities. For attestation, the decision of whether or not to trust a computing device may depend on the software and hardware of the device; for example, if any components are associated with a security threat, then the computing device may not be attested. If the origin of a security threat is unknown, affected devices could also be compared with respect to their software and hardware components in order to identify commonalities that could represent the source of the security threat. However, conventional approaches to network security do not typically obtain a comprehensive listing of software components and/or hardware components, and there is no consistent, universal approach to describing the constituent elements of a hardware and/or software configuration.

Accordingly, present embodiments solve this problem by providing a universal reference that is unique for each combination of hardware and/or software elements. As referred to herein, a computing entity can be defined as any combination of software and/or hardware elements. The universal reference can have a small data footprint (e.g., 20 bytes), and can be used to determine with specificity an exhaustive listing of all components of a computing entity. This universal reference is obtained by representing software and/or hardware components using a hierarchical description in which relationships between components and sub-components are defined. A universal reference can then be generated for each component in the hierarchical description based on the sub-components immediately below the component in the hierarchical description. By nature of the hierarchical description, the universal references of the components and sub-components enable an exhaustive description of any software and/or hardware configuration to be obtained via a single universal reference. In particular, the hierarchical description may be similar to a Merkle tree, in which leaf nodes are labeled with hashes of data blocks, and non-leaf nodes store hashes of child nodes. The relationships between universal references and the components of the computing entity with which each universal reference is associated can be stored in a trusted repository. The repository can be queried using a universal reference to identify the hardware/software components. Additionally, universal references can be used to quickly determine whether a particular software and/or hardware configuration includes any known good (e.g., approved) and/or bad (e.g., disapproved) components.

Thus, present embodiments provide the practical application of enabling any software and/or hardware configuration to be succinctly and exhaustively described, no matter how complex, in a consistent manner by providing a universal reference to describe any possible combination of constituent hardware and/or software elements. The knowledge of constituent software and/or hardware elements, or inventory, can be used for policy enforcement or attestation purposes by determining whether a computing entity includes any hardware or software with known vulnerabilities, exploits, or other issues. Moreover, universal references can be logged for security purposes, and when a security event impacts a group of different software objects and/or hardware configurations, their universal references can be used to obtain and compare hierarchical descriptions in order to identify common components that are likely associated with the security event. Accordingly, claimed embodiments improve the fields of computer and network security by enabling an exhaustive description of any combination of software and/or hardware to be easily captured using a lightweight universal reference that can, for example, be inserted into Hypertext Transfer Protocol (HTTP) headers, compiled into software to provide self-referential executables, and/or otherwise shared in order to achieve any desired computing security goal.

Accordingly, the universal references presented herein enable an exhaustive list of components of an executing system to be conveyed in a succinct (e.g., 20-byte) identifier that can be exchanged between systems. In communications between two executables, such as remote procedure calls (RPCs) or representational state transfer (REST or RESTful) communications, the requesting entity can share its universal identifier with the responding entity, and/or the responding entity can share its universal identifier with the requesting entity. Thus, any executing system can plan as to whether it trusts the other system to remotely execute data, exchange data, and the like. Universal references can be used to secure any communications, including RPC communications, push-streamed telemetry communications (e.g., Kafka communications), and the like. Additionally, universal identifiers can be logged for each interaction to provide a history of interactions with remote computing systems that can later be used to determine whether a system was exposed to a vulnerability. For example, when a vulnerability in a component becomes known, a log can be scanned for any universal references that are associated with an executing system that included the vulnerable component. Thus, present embodiments support data forensics tasks by enabling researchers to identify any transactions that involved a potentially vulnerable component.

The universal reference, or GitBOM identifier, can thus be inserted into a metadata field of any request or response to provide a layer of security and enhanced logging capability. The universal identifier can be used by another executable to determine whether to permit or deny the request/response on a message/transaction-level (rather than merely a connection-level). In some embodiments, the operation of determining whether an executable is secure, based on its provided universal reference, is performed by a sidecar (or similar “helper” application) to offload that operation from the main requesting/responding executable. The universal reference can be logged so that when a vulnerability later becomes known, impacted universal references can be determined and each transaction can be reviewed to determine whether it was affected. The logging of universal references may also be performed by a sidecar (or similar “helper” application, such as a middleware service or proxy) to offload that operation from the main requesting/responding executable.

Using a universal reference, or GitBOM identifier, a responding executable (also referred to as a “responder” or “responding entity”) can determine the components of the requesting executable (also referred to as a “requestor” or “requesting entity”). Knowing the components enables a responder to have the option to automatically deny an RPC request if there is a day-zero vulnerability recently discovered that is deep within the requester's software. Inserting an attested GitBOM identifier for the requestor and/or responder in the metadata for an interaction, such as a RPC interaction, enables: the RPC responder to utilize the GitBOM identifier from the requestor to make authorization decisions, such as whether or not to accept the RPC; the RPC requestor to utilize the GitBOM identifier from the responder to make decisions about whether or not to accept the information returned by the RPC; both requestor and responder to log the GitBOM identifier for later forensic use; and an intermediate service mesh (e.g., a middleware service or proxy) or centralized logging service (e.g. a security information and event management (SIEM) service) to log the GitBOM identifiers for purpose of inventorying precisely what software is in use in an enterprise.

Additionally, remote attested GitBOMs generated from Confidential Compute environments like Intel® Software Guard Extensions (SGX), Advanced Micro Devices, Inc. (AMD) Secured Encryption Virtualization—Secure Nested Paging (SEV-SNP), and ARM® TrustZone should all result in hardware-rooted GitBOM identifiers in a way that the requestor cannot spoof.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description and appended claims, or may be learned by the practice of embodiments as set forth hereinafter.

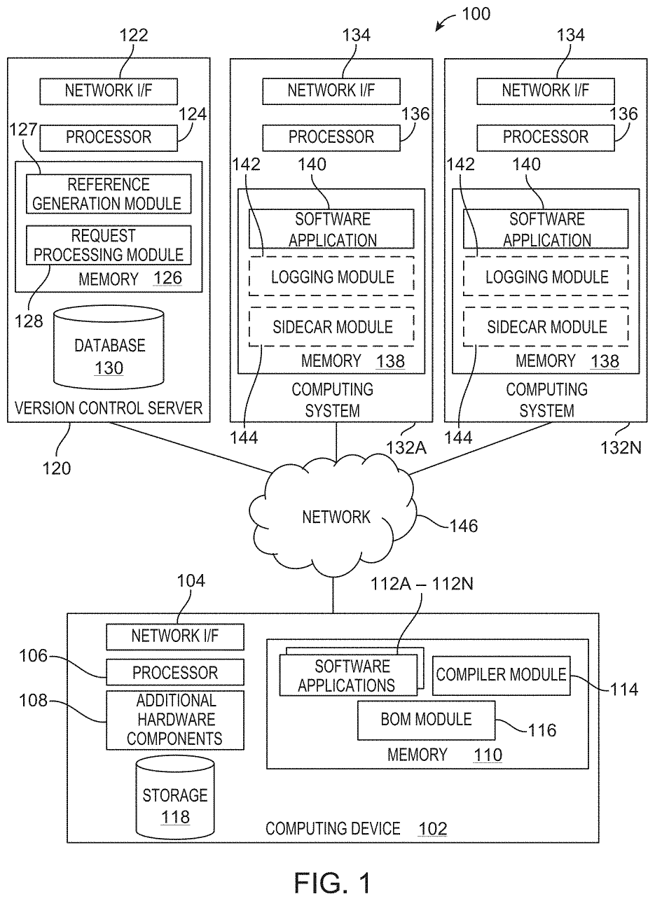

Embodiments are now described in detail with reference to the figures. FIG. 1 is a block diagram depicting an environment 100 for performing logging, securing communications, and/or performing digital forensics, in accordance with an example embodiment. As depicted, environment 100 includes a computing device 102, a version control server 120, computing systems 132A-132N, and a (communication) network 146. It is to be understood that the functional division among components of environment 100 have been chosen for purposes of explaining various embodiments and is not to be construed as a limiting example.

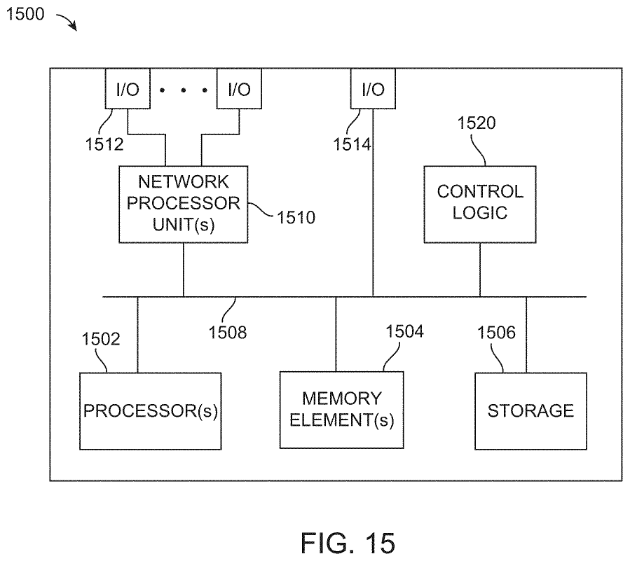

Computing device 102 includes a network interface (I/F) 104, at least one processor 106, additional hardware components 108, memory 110, and storage 118. Memory 110 stores software instructions for software applications 112A-112N, a compiler module 114, and a Bill of Materials (BOM) module 116. Computing device 102 may include, for example, a laptop computer, a tablet computer, a netbook computer, a personal computer (PC), a desktop computer, a personal digital assistant (PDA), a smart phone, a thin client, a rack-mounted server, or any programmable electronic device capable of executing computer readable program instructions. Network interface 104 may include one or more network interface cards, line cards, etc., and enables components of computing device 102 to send and receive data over a network, such as network 146. In general, computing device 102 represents any configuration of software and/or hardware components that can be described using a universal reference in accordance with the embodiments presented herein. Computing device 102 may include internal and external hardware components, as depicted and described in further detail with respect to FIG. 15.

Additional hardware components 108 may include any hardware elements associated with computing device 102, each of which can be described using a universal reference. Additionally, the constituent elements of each of the additional hardware components 108 can also be described with a universal reference. For example, a camera may have a universal reference for itself that indicates a component of the camera, such as a particular complementary metal-oxide semiconductor (CMOS) image sensor, via another universal reference. As a non-exhaustive listing for illustrative purposes, additional hardware components 108 can include cameras, graphical processing units (GPUs), peripheral devices (keyboards, mice, microphones, speakers, etc.), application-specific integrated circuits (ASICs), sensors, batteries, and the like. In some embodiments, computing device 102 may be a computer associated with a vehicle, robot, scientific equipment, diagnostic device, and the like, and additional hardware components 108 may include specialized elements such as motors, lasers, transceivers, robotic components, propellers, x-ray generators, liquid pumps, transducers, and the like.

Software applications 112A-112N, compiler module 114, and BOM module 116 may include one or more modules or units to perform various functions of the embodiments described below. Software applications 112A-112N, compiler module 114, and BOM module 116 may be implemented by any combination of any quantity of software and/or hardware modules or units, and may reside within memory 110 of computing device 102 for execution by a processor, such as processor 106.

Software applications 112A-112N can include any executable software application, each of which can be described using a universal reference. Additionally, the modules that constitute each software application 112A-122N can also be described with their own universal reference. For example, a software application may be assigned a universal reference that indicates that the software application includes a plug-in or extension, and the plug-in or extension can be assigned its own universal reference (which is referenced by the parent software application's universal reference). Software applications 112A-112N can include, for example, word processors, web browsers, games and entertainment applications, mail and calendar applications, control software, modeling software, computer aided design (CAD) software, firmware, and any other executable software.

Compiler module 114 may include any conventional or other compiler that translates computer code written in one programming language into another language (e.g., machine-language instructions). Compiler module 114 may generate one or more of software applications 112A-112N. In order to create self-referential software objects, compiler module 114 may receive or obtain a universal reference for the software object being compiled and insert the universal reference into the compiled software object in a manner that embeds the software object's universal reference into the software object. Thus, a software object can self-identify using its universal reference for attestation and other security tasks.

BOM module 116 manages one or more bills of materials for software and/or hardware associated with computing device 102. A bill of materials is a list of components for a computing entity, including any software or hardware object. Each bill of materials may have a hierarchical schema in which the top level represents an object itself and lower levels represent sub-components. Each component can be referenced in a bill of material by any identifier, including a name, version number, universal unique identifier (UUID), hardware identifier (e.g., vendor-defined strings used to identify devices), and the like. In some embodiments, BOM module 116 scans computing device 102 and obtains bills of materials for each hardware and/or software component. BOM module 116 may obtain bills of materials from one or more network-accessible locations associated with manufacturers or vendors. In some embodiments, one or more bills of materials are provided to computing device 102 by the software and/or hardware components themselves.

Storage 118 may include any non-volatile storage media known in the art. For example, storage 118 can be implemented with a tape library, optical library, one or more independent hard disk drives, or multiple hard disk drives in a redundant array of independent disks (RAID). Similarly, data in storage 118 may conform to any suitable storage architecture known in the art, such as a file, a relational database, an object-oriented database, and/or one or more tables. Storage 118 may store data relating to software and/or hardware components of computing device 102, including bills of materials, and universal references for computing entities.

Version control server 120 includes a network interface (I/F) 122, at least one processor 124, memory 126, and a database 130. Memory 126 stores software instructions for a reference generation module 127 and a request processing module 128. Version control server 120 may include a rack-mounted server, or any other programmable electronic device capable of executing computer readable program instructions. Network interface 122 may include one or more network interface cards, line cards, etc., and enables components of version control server 120 to send and receive data over a network, such as network 146. In general, version control server 120 creates universal references, stores associations between software and/or hardware configurations and their respective universal references, and processes queries to identify the components of computing entities based on their universal references. In some embodiments, version control server 120 performs other distributed version control system functions, and may include, for example, a Git server. Version control server 120 may include internal and external hardware components, as depicted and described in further detail with respect to FIG. 15. Version control server 120 may be embodied as a software application 112A-112N running on a computing device 102.

Reference generation module 127 and request processing module 128 may include one or more modules or units to perform various functions of the embodiments described below. Reference generation module 127 and request processing module 128 may be implemented by any combination of any quantity of software and/or hardware modules or units, and may reside within memory 126 of version control server 120 for execution by a processor, such as processor 124.

Reference generation module 127 may generate universal references for computing entities in accordance with present embodiments. A computing entity can include software, hardware, firmware, or combinations thereof, such as an executable software object, runtime libraries used by the software object at execution, and the hardware configuration upon which the software object executes. These hardware/software elements may also be referred to as artifacts. In general, a computing entity's artifacts are processed by reference generation module 127 to generate universal references. The contents of each artifact are stored in the reference generation module 127 as an object. Each object may be stored as a binary file (e.g., a Git binary large object (blob)). A universal reference is created for each object by computing a cryptographic hash of the object. If the artifact contains child artifacts, the universal references of those child artifacts are combined into another object, referred to as the bill of materials (BOM) object, which is hashed to create the BOM universal reference for these child artifacts. Universal references for the immediate leaf nodes of the given artifact are listed alongside a BOM universal reference of any child nodes to create a hierarchical representation of the artifact and its subcomponents.

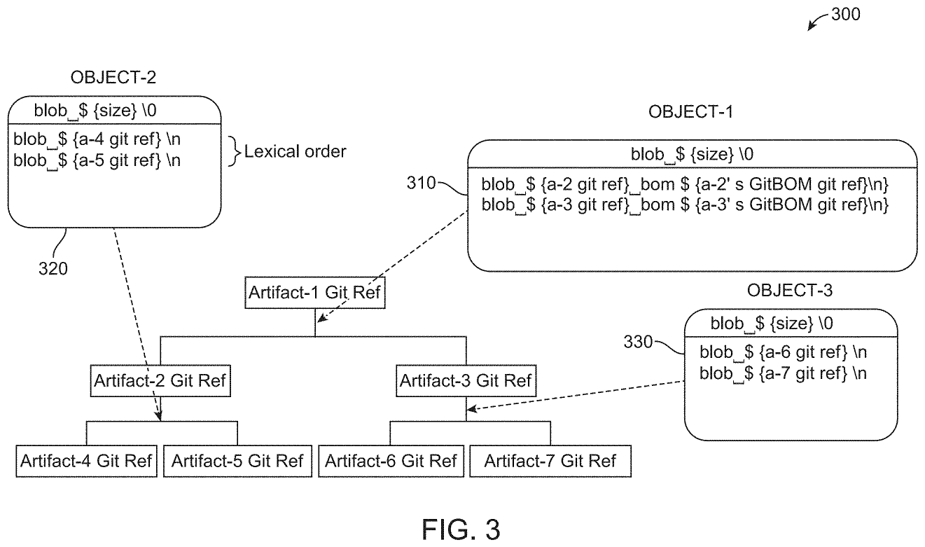

Thus, the specific BOM object (e.g., Git reference) that is associated with the parent artifact at the very top of the hierarchical representation will include the universal references of its immediate child artifacts; each child artifact's own universal reference indicates its child artifacts, etc., thus enabling a computing entity to be exhaustively described using a single BOM object (i.e. the hash of the object of the uppermost parent artifact of the hierarchy combined with the hash of the child artifacts' BOM object universal references). Generation of universal references is depicted and described in further detail with respect to FIGS. 3-5.

Request processing module 128 processes requests that include universal references to determine an exhaustive listing of the components of the computing entities associated with the universal references. When a universal reference is received, request processing module 128 may query database 130 to determine the object associated with the universal reference; the contents of the object indicate all of the artifacts that are immediate children of the computing entity by their own universal references. Request processing module 128 may iteratively look up each child artifact's children until a full listing of all components of the computing entity is obtained. Request processing module 128 can then respond to a request with the exhaustive listing of components associated with the computing entity whose universal reference was provided in the request. In some embodiments, request processing module 128 may only provide a portion of the components of a computing entity; for example, if only software components are relevant, then the request may include an indication to only return the software components.

Database 130 may include any non-volatile storage media known in the art. For example, database 130 can be implemented with a tape library, optical library, one or more independent hard disk drives, or multiple hard disk drives in a redundant array of independent disks (RAID). Similarly, data in database 130 may conform to any suitable storage architecture known in the art, such as a file, a relational database, an object-oriented database, and/or one or more tables. Database 130 may store associations between universal references and objects (e.g., Git blobs) that in turn contain other universal references. Database 130 may also store associations between objects and the identities of the particular computing entities that each object represents.

Computing systems 132A-132N each include a network interface (I/F) 134, at least one processor 136, and memory 138. Memory 138 stores software instructions for a software application 140 and optionally, a logging module 142 and a sidecar module 144. Computing systems 132A-132N may each include a rack-mounted server, or any other programmable electronic device capable of executing computer readable program instructions. Network interface 134 may include one or more network interface cards, line cards, etc., and enables components of each of computing systems 132A-132N to send and receive data over a network, such as network 146. In general, computing systems 132A-132N include two or more computing systems that support the execution of applications (e.g., software application 140) and secured communication between applications. Computing systems 132A-132N may include internal and external hardware components, as depicted and described in further detail with respect to FIG. 15.

Software application 140, logging module 142, and/or sidecar module 144 may include one or more modules or units to perform various functions of the embodiments described below. Software application 140, logging module 142, and/or sidecar module 144 may be implemented by any combination of any quantity of software and/or hardware modules or units, and may reside within memory 138 of any of computing systems 132A-132N for execution by a processor, such as processor 136.

Software application 140 may include any software application that performs any desired operation, including processing operations, communication operations, and the like. In particular, software application 140 may exchange data with another software application 140 executing on another computing system. For example, software application 140 of computing system 132A may exchange data with software application 140 of computing system 132N to support a remote procedure call, a communication session, and the like.

In order to securely communicate, software application 140 may use a universal reference of a remote application to determine whether software application 140 is authorized to communicate with the remote application. Since a universal reference can exhaustively identify the software and/or hardware components of a computing system, the universal reference may indicate whether an application includes any known components that would cause communication with that application to be undesired. For example, a component may include a vulnerability or other security concern. Similarly, a software application may require that a remote computing entity include certain components, such as a particular component for encrypting and decrypting data, a particular antivirus, and the like.

Each software application 140 may provide a universal reference that corresponds to the software application 140 or another relevant universal reference, such as the universal reference for the computing system upon which the software application 140 is executing (e.g., computing system 132A-132N). In an exchange of data between two software applications 140, either software application 140 or both software applications 140 may provide a universal reference to the other software application 140. In various embodiments, the universal reference may be inserted into a metadata field, an Internet Protocol (IP) packet field, and the like.

Logging module 142 and sidecar module 144 may perform operations that support the secure communication between software applications 140. In various embodiments, either or both of logging module 142 and sidecar module 144 may be optional, as it should be understood that software application 140 may perform some or all of their functions described herein.

Logging module 142 may log events associated with communication of software applications 140. In some embodiments, logging module 142 performs conventional logging operations, such as logging time-series data that describes network events. In some embodiments, logging module 142 may obtain and store universal references that are passed between software applications 140. The universal references may also be stored in a time-series manner to indicate the time at which each communications involving a universal references occurs. Logging module 142 may additionally store a record of each particular software application sent and/or received a universal reference, and/or an indication of the type of communication (e.g., purpose of communication, protocol(s) used, etc.).

Sidecar module 144 may perform various operations to support software application 140, and may include, for example, an instantiated container (e.g., a Kubernetes container) that is separate from the instantiated container of software application 140. In some embodiments, sidecar module 144 may act as an intermediary between software application 140 and logging module 142. As such, sidecar module 144 may obtain or receive data from software application 140 and/or an event monitor, and provide the data to logging module 142 for logging purposes. In some embodiments, sidecar module 144. In some embodiments, sidecar module 144 may perform some or all of the operations necessary to authorize communication between software applications 140 in accordance with present embodiments. In particular, sidecar module 144 may obtain a universal reference from a remote software application 140, transmit a universal reference of a local software application 140 to another application, and/or determine whether communication between software applications 140 should be permitted on the basis of either or both of the universal references of the software applications 140.

Network 146 may include a local area network (LAN), a wide area network (WAN) such as the Internet, or a combination of the two, and includes wired, wireless, or fiber optic connections. In general, network 146 can be any combination of connections and protocols known in the art that will support communications between computing device 102, version control server 120, and/or computing systems 132A-132N via their respective network interfaces in accordance with the described embodiments.

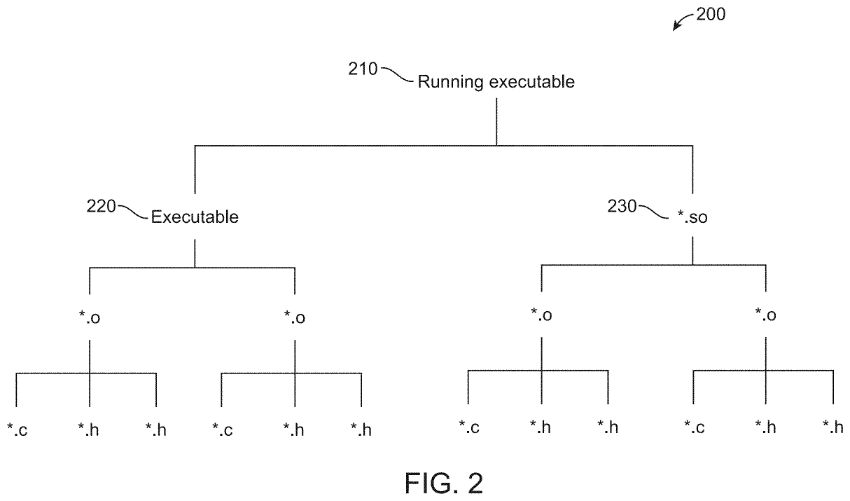

FIG. 2 is a tree diagram depicting a hierarchical description 200 of a computing entity, in accordance with an example embodiment. In the depicted embodiment, the computing entity represented by hierarchical description 200 may include a C or C++ running executable 210. Running executable 210 may include as immediate child artifacts executable 220 and dynamic library 230 (*.so), which is not embedded in the binary of executable 220 but is utilized at runtime. Hierarchical description 200 also indicates that executable 220 includes child artifacts (*.o) which also have child artifacts (*.c, *.h); likewise, dynamic library 230 includes child artifacts (*.o) that also have child artifacts (*.c, *.h). Accordingly, hierarchical description 200 may represent an exhaustive description of the components of running executable 210, and as such, can be used for various security purposes, such as attestation and other tasks.

FIG. 3 is a tree diagram depicting a hierarchical description 300 of universal references for a computing entity's artifacts composed into bill of materials (BOM) objects, in accordance with an example embodiment. As depicted, a top-level BOM object (“object-1”) has two immediate children (“object-2” and “object-3”) which also have two immediate children each. Object-1 is a BOM object 310, which may be structured as a Git blob. The contents of object 310 include the universal references (e.g., “git ref”) of its immediate children, artifact-2 and artifact-3 along with universal references to their BOM objects (e.g., “gitBOM git references,” “Git object identifier (GitOID)” or “git refs”). Likewise, object 320, which is associated with artifact-2, includes as contents the universal references to its immediate children (“artifact-4” and “artifact-5”), and object 330, which is associated with artifact-3, includes as contents the universal references to its immediate children (“artifact-6” and “artifact-7”). While FIG. 3 is described as a tree diagram, it should be appreciated that this data can be represented in any suitable manner, such as a graph.

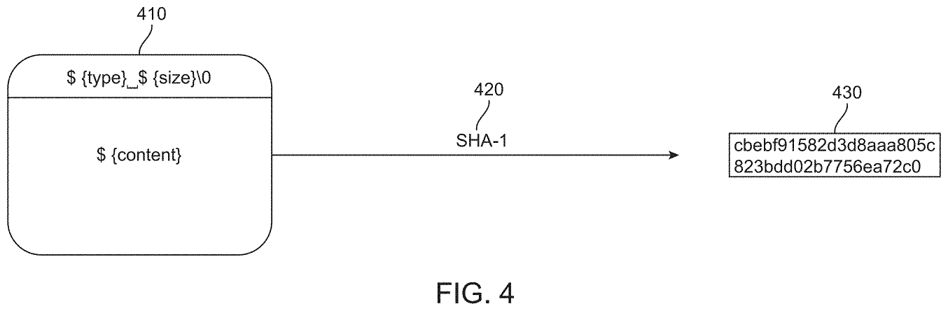

FIG. 4 is a block diagram depicting a universal reference 430 being generated based on an object 410, in accordance with an example embodiment. As depicted, object 410 has contents that can include one or more universal references for the immediate child artifacts of the artifact to which object 410 corresponds. A hashing algorithm 420, such as Secure Hash Algorithm 1 (SHA-1), may be applied to object 410 to generate universal reference 430, which may be a 40-character hexadecimal string. In various embodiments, the hashing algorithm 420 that is applied may include a collision-resistant hashing algorithm in order to ensure that universal references are unique for unique combinations of hardware and/or software.

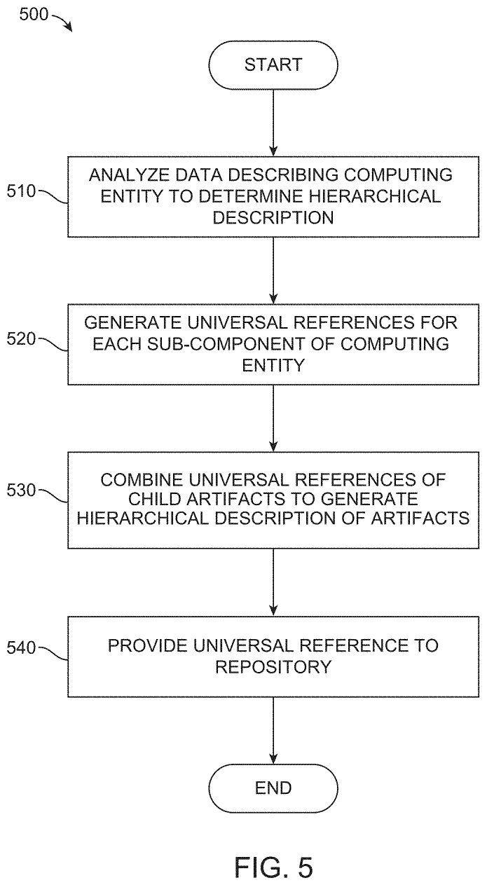

FIG. 5 is a flow chart depicting a method 500 for generating a universal reference, in accordance with an example embodiment.

Data describing a computing entity is analyzed to determine a hierarchical description at operation 510. The data may include a bill of materials (BOM) for the computing entity. In some embodiment, the BOM is a structured document that describes the components of the computing entity, and the relationships between components are explicitly defined, enabling the hierarchical description to be directly determined. In some embodiments, the BOM is at least partially unstructured, and relationships between components may require extraction by processing the BOM. In one embodiment, a natural language processing model may be utilized to analyze an unstructured description of a computing entity in order to extract relationships between components. The natural language processing model may be trained using a set of training data that includes examples of unstructured descriptions and the corresponding hierarchical descriptions based on those unstructured descriptions. In some embodiments there is no BOM and operation 510 requires evaluation of the artifacts' development, integration, and/or relationships such as might be contained in a version control server. Each artifact of the hierarchical description may be provided with a BOM object (e.g., a Git blob) whose contents cite, via universal references, the immediate child artifacts.

Universal references for each sub-component of the computing entity are generated at operation 520. Each sub-component may be processed using an algorithm, such as a collision-resistant hashing algorithm, to produce a string that is used as the universal reference. The algorithm may output strings of uniform length so that all universal references occupy a same number of bits. In some embodiments, any metadata contained in the object may be removed, so that same hardware or software components that include different descriptive or other details may be correctly mapped to the same universal references.

The universal references of child artifacts are combined to generate a hierarchical description of the artifacts at operation 530. This process is repeated for parent artifact, proceeding in a bottom-up approach through each tier of the hierarchy, until an exhaustive universal reference of a computing entity is generated.

The universal reference is provided to a repository at operation 540. Each generated universal reference may be provided to a repository along with the associated identities and/or universal references of the immediate child artifacts of the artifact from which the universal reference was generated. Accordingly, the repository may be queried to determine immediate child artifacts of a computing entity, and, using their universal references, queried again to determine their child artifacts, etc., until an exhaustive description of the computing entity's components is obtained.

Accordingly, universal references enable any software and/or hardware configuration to be succinctly and exhaustively described, no matter how complex, in a consistent manner. In a communication between two executables, the requesting entity (e.g., the application that initiates the communication) can share a universal reference with the responding entity, and/or the responding entity can share a universal reference with the requesting entity. By exchanging universal references, any executing application can make a decision as to whether it trusts another application (or the other application's system), to perform functions such as providing data to the requesting application, remotely executing operations, and the like.

In particular, a universal reference can be inserted into a metadata field of any request or response to provide a layer of security and to support enhanced logging capabilities. Thus, universal identifiers can be used by applications to determine whether to permit or deny any request or response on a connection-level or even on a message/transaction-level.

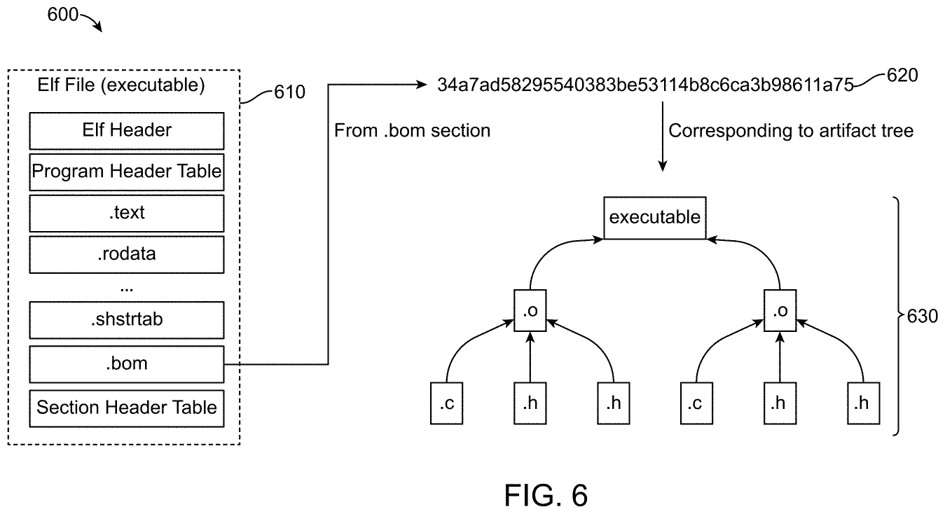

FIGS. 6-14, described below, provide examples of various ways to use the universal references in communications between executables.

FIG. 6 is a tree diagram 600 depicting a hierarchical description of an executable file's artifacts, in accordance with an example embodiment. Also depicted in FIG. 6 is an executable file 610, including the contents of the executable file 610, and a universal reference 620.

As depicted, executable file 610 includes several sections or portions of data (e.g., “Elf header,” “Program Header Table,” “.text,” “.rodata,” “.shstrtab,” “.bom,” “Section Header Table,” etc.). Executable file 610 may correspond to an application, such as software application 140, which is depicted and described with reference to FIG. 1. The “.bom” section may include a universal reference (e.g., a GitBOM identifier) that is inserted into the application at compilation, and which may be used to obtain an exhaustive description of the contents of the executable file 610. As shown, universal reference 620 can be extracted from the “.bom” section of executable file 610. The universal reference 620 can then be used as a reference to identify the universal references of any components and sub-components, thereby enabling artifact tree 630 to be obtained. Accordingly, each component of executable file 610 can be determined.

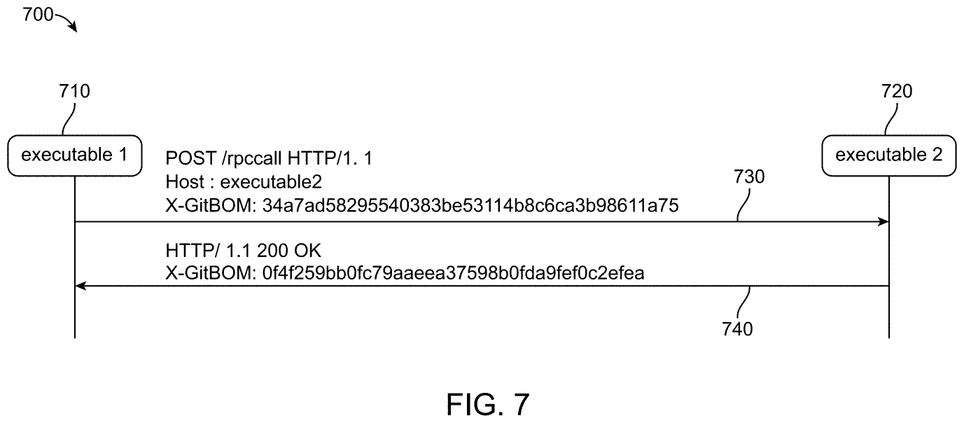

FIG. 7 is a sequence diagram 700 depicting a communication between executables, in accordance with an example embodiment. As depicted, flow diagram 700 includes a first application 710 (“executable 1”) and a second application 720 (“executable 2”); in the depicted embodiment, application 710 is initiating the communication between the executable applications.

Initially, application 710 transmits a message that includes a universal reference. In the depicted example, the request 730 is a remote procedure call (“rpccall”), which indicates a request for the receiving entity (e.g., application 720) to perform a specified operation. The universal reference may be included in request 730 as metadata.

Application 720 may process the request and respond with response 740, which includes another universal reference (e.g., the universal reference associated with application 720 or the computing system in which application 720 is executing). Accordingly, applications 710 and 720 may exchange universal references so that each application can determine whether further communication is permitted with the other application.

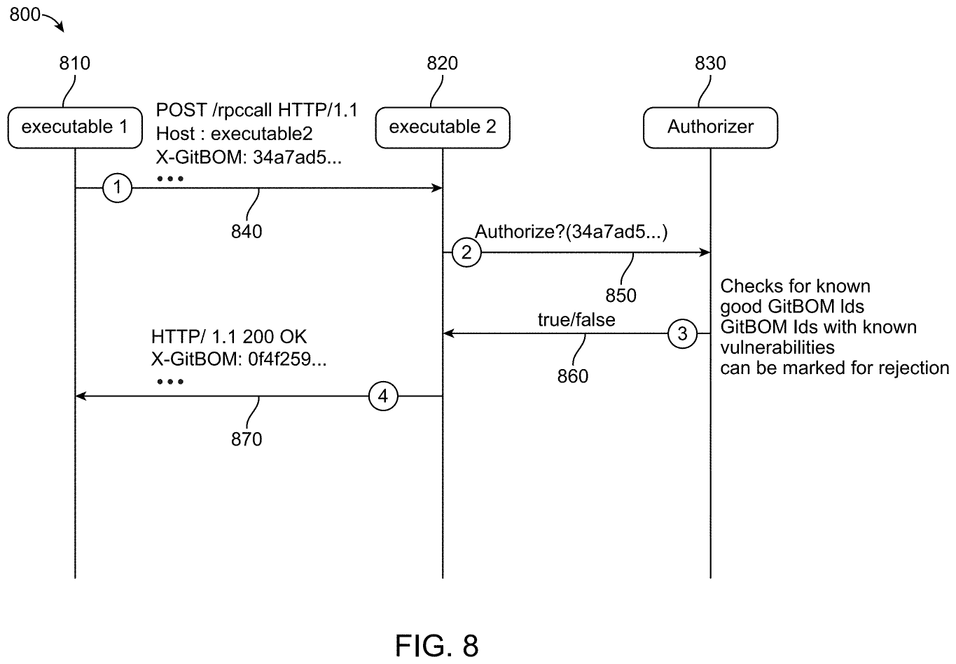

FIG. 8 is a flow diagram 800 depicting a communication between executables and an authorizer, in accordance with an example embodiment. As depicted, application 810 (“executable 1”) is initiating communication with application 820 (“executable 2”); an authorizer 830 performs operations to authorize application 820 to communicate with application 810. Authorizer 830 may be an application such as sidecar module 144, which is depicted and described with reference to FIG. 1.

Initially, application 810 transmits request 840 to application 820; request 840 may include a universal reference associated with application 810. Upon receiving request 840, application 820 forwards the universal reference to authorizer 830 in an authorization request 850. Authorizer 830 may then determine whether the universal reference is associated with any vulnerabilities, by either comparing the universal reference to a known authorized/approved list and/or a known unauthorized/disapproved list of universal references, or by using the universal reference in accordance with present embodiments to exhaustively identify all components of application 810.

Once authorizer 830 determines that communication with application 810 is authorized, an authorization message 860 is transmitted back to application 820. Application 820 may then transmit a response 870 back to application 810, which can include a universal reference of application 820, and a communication session may subsequently be established between applications 810 and 820.

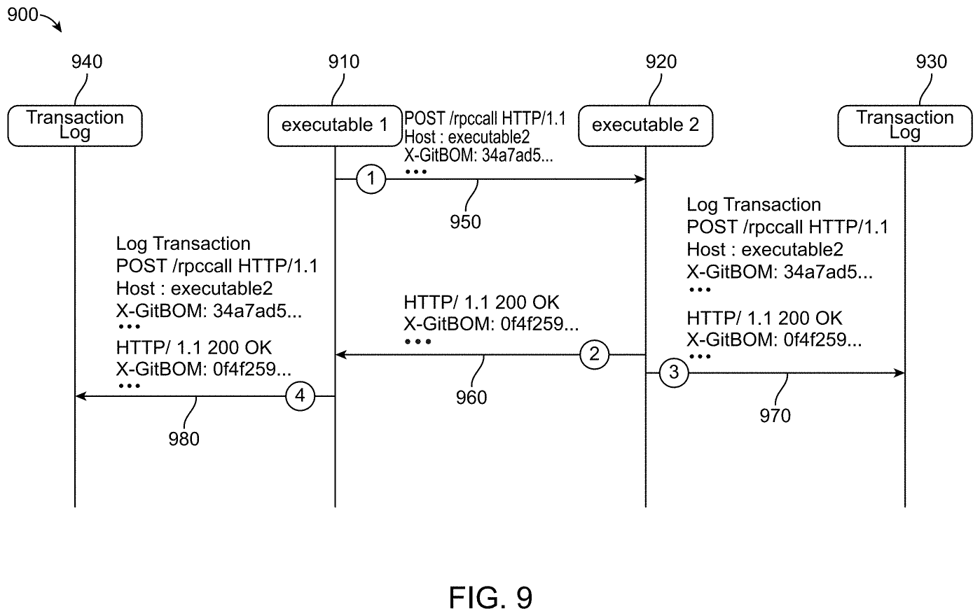

FIG. 9 is a flow diagram 900 depicting a communication between executables that is logged, in accordance with an example embodiment. As depicted, communication between application 910 (“executable 1”) and application 920 (“executable 2”) is logged in transaction log 930 and transaction log 940, each of which is associated with an application.

Initially, application 910 transmits a request 950 to application 920 that includes a universal reference. Once request 950 is received, application 920 may provide the universal reference to transaction log 930 at operation 970. Accordingly, the universal reference of application 910, as well as the universal reference application 920, may be stored in transaction log 930 for subsequent analysis (e.g., data forensics, etc.). Application 920 may also respond to request 950 with response 960, which includes another universal reference (e.g., a universal reference associated with application 920 or the system executing application 920). Similarly, application 910 may also transmit the transaction details to transaction log 940 at operation 980. It should be appreciated that this logging example is only one possible example implementation, and universal references may be logged more or less frequently depending on various desired logging configurations.

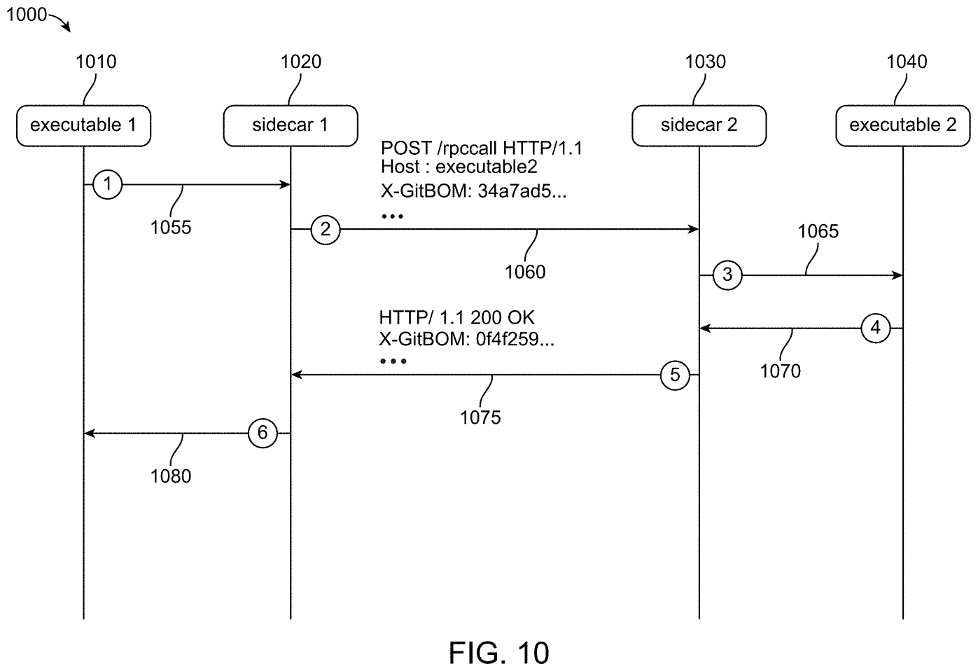

Turning now to FIG. 10, a flow diagram 1000 illustrates a communication between executables using sidecar applications to offload operations, in accordance with an example embodiment. As depicted, communication between application 1010 (“executable 1”) and application 1040 (executable 2”) is intermediated by sidecar 1020 (“sidecar 1”) and sidecar 1030 (“sidecar 2”).

Initially, application 1010 initiates a communication session by transmitting a request 1055 to communicate with application 1040 to sidecar 1020, which could handle the exchange of universal references on behalf of application 1010. Once sidecar 1020 receives request 1055, sidecar 1020 transmits a request 1060 to sidecar 1030. Request 1060 may include a universal reference that is associated with application 1010 or the computing system in which application 1010 is executing.

Sidecar 1030 may receive request 1060, and process the universal reference on behalf of application 1040, optionally authorize the request, and forward the message on to application 1040 at operation 1065. Application 1040 may respond to the message of operation 1065 with message 1070, whereupon sidecar 1030 may provide a universal reference for application 1040 or the computing system in which application 1040 is executing at operation 1075. Thus, sidecar 1030 may respond to request 1060 with a response at operation 1075 that includes the universal reference that is associated with application 1040 (or the computing system in which application 1010 is executing). Sidecars 1020 and 1030 may authorize the transaction between applications 1010 and 1040 based on the universal references, and a response 1080 may be transmitted from sidecar 1020 to application 1010 indicating that communication is permitted. Additionally or alternatively, response 1080 may acknowledge that application 1040 has performed a requested operation, and/or response 1080 may include data that application 1010 requested from application 1040.

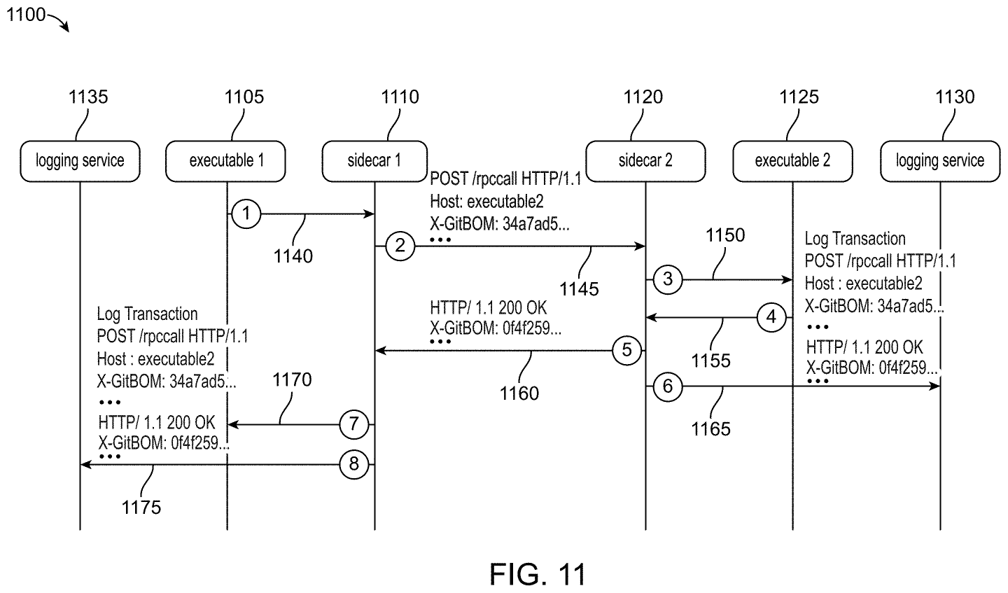

FIG. 11 is a flow diagram 1100 depicting a communication between executables using sidecars and logging, in accordance with an example embodiment. As depicted, application 1105 (“executable 1”) communicates with application 1125 (“executable 2”), a communication that is intermediated by sidecar 1110 (“sidecar 1”) and sidecar 1120 (“sidecar 2”); logging services 1130 and 1135 log aspects of the communication.

Initially, application 1105 initiates the communication session by transmitting a request via message 1140 to sidecar 1110 to handle the exchange of universal references and authorization of communication. Sidecar 1110 transmits a request via message 1145 to sidecar 1120 that includes the universal reference of application 1105. Once message 1145 is received, sidecar 1120 may process the universal reference, authorize the communication, and forward the request on to application 1125 via 1150, which can respond via message 1155, enabling sidecar 1120 to generate a universal reference associated with application 1125 (or the computing system in which application 1125 is executing) and send it to sidecar 1110 via message 1160. Additionally, sidecar 1120 may provide data to logging service 1130 via message 1165, so that the universal references of both application 1105 and application 1125 may be logged. The sidecar 1120 may choose to log more or less messages, for example only logging the completed transaction with message 1165 or logging each of messages 1145, 1150, 1155, and 1160.

Sidecar 1120 may respond to request 1145 with message 1160, which includes the universal reference associated with application 1125 (or the computing system in which application 1125 is executing). Once message 1160 is received, sidecar 1110 may authorize application 1105 to receive data from application 1125, which is provided via message 1170. Additionally, sidecar 1110 may provide the details of the transaction (including the universal references associated with applications 1105 and 1125) to logging service 1135 for logging via message 1175. Sidecar 1110 may select to log more or less messages, for example only logging the completed transaction with message 1175 or logging each of messages 1140, 1145, 1160, and 1170.

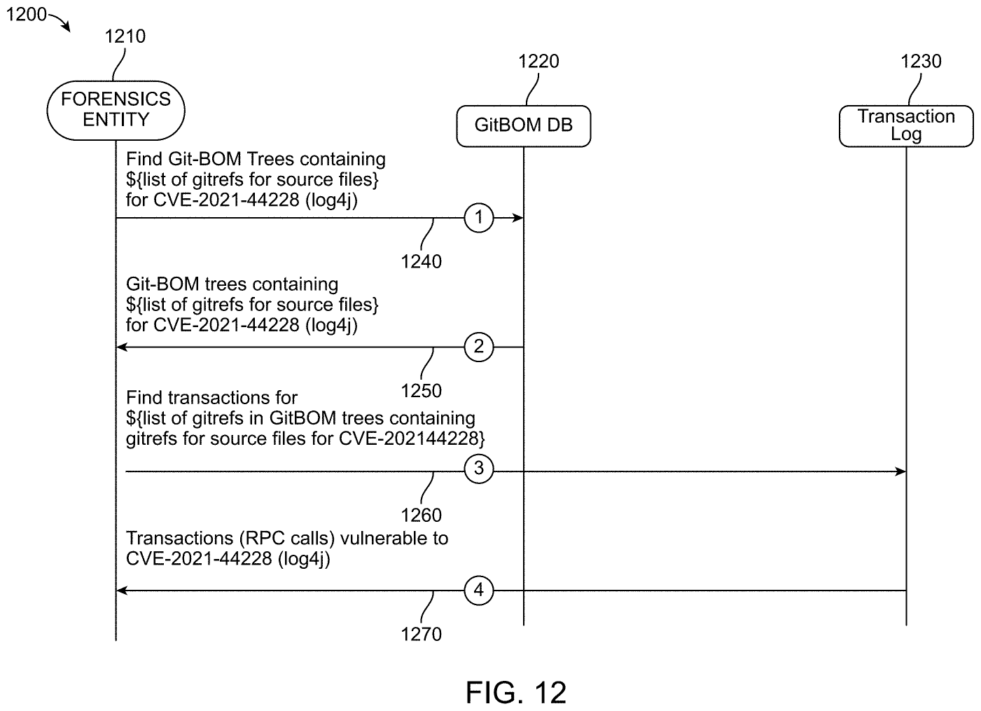

FIG. 12 is a flow diagram 1200 depicting the use of universal references to perform forensics, in accordance with an example embodiment. As depicted, a forensics entity 1210 is used to investigate a particular vulnerability (e.g., “CVE-2021-44228” also referred to as “log4j”). Forensics entity 1210 may be a computing device associated with a network administrator, as an example.

Initially, forensics entity 1210 searches database 1220 for any universal references that match components known to be affected by the vulnerability (e.g., log4j). Forensics entity 1210 may provide query 1240 to database 1220 in order to search the database. Database 1220 may include a database that stores associations between universal references and objects (e.g., Git blobs) that in turn contain other universal references, as described in further detail above with respect to FIG. 2 and FIG. 3. Database 1220 may correspond to database 130 that is depicted and described in further detail above with respect to FIG. 1.

Database 1220 may provide a response 1250 that includes a list of any universal references associated with computing entities that are known to be vulnerable. Using these universal references, forensics entity 1210 may then analyze transaction log 1230 at operation 1260 for any events in which an application, having a universal reference associated with a known vulnerable component, is listed as a participant. Transaction log 1230 may provide these events via response 1270, which forensics entity 1210 can use to narrow down any potentially affected transactions, applications, and/or computer systems that require further investigation.

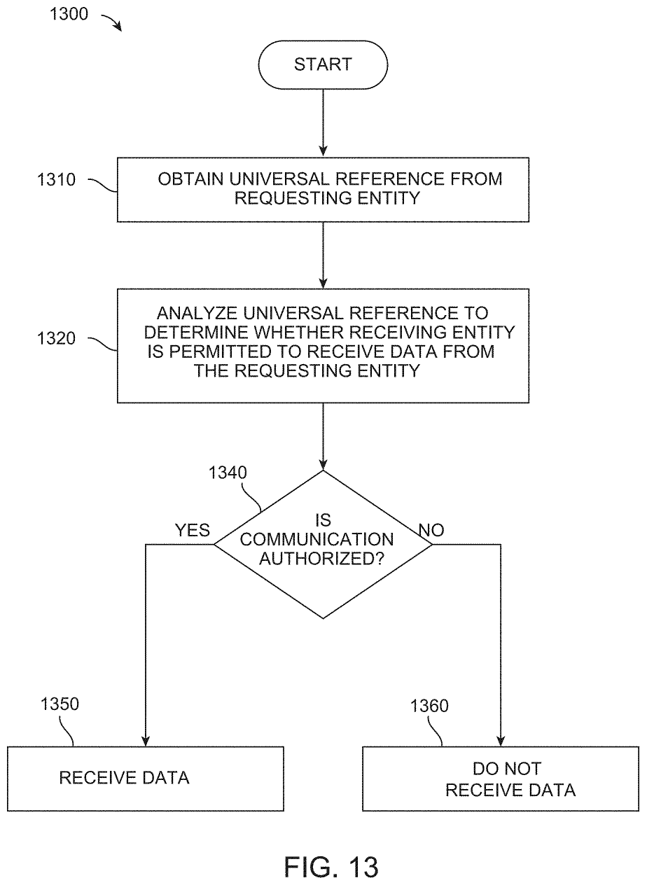

FIG. 13 is a flow chart 1300 depicting a method for secured communication between applications using a universal reference, in accordance with an example embodiment.

At operation 1310, a universal reference is obtained from a requesting entity (e.g., an entity requesting to initiate a transaction with a receiving entity). The requesting and receiving entities may include any executing application, such as software applications 140 and 112A-112N in FIG. 1. The universal reference may be obtained from a request, where the universal reference is inserted into a metadata field or other field, or the universal reference may be provided in an ad hoc transmission of the universal reference. The receiving entity may choose to verify the universal reference it obtains from the requesting entity. Verification can be performed using software or hardware-based attestation and validation techniques, such as hardware-based private key signing of the universal reference of the requesting entity. Attestation can be performed by providing evidence of a cryptographically signed universal reference using software or hardware-based cryptographic mechanisms.

At operation 1320, the universal reference is analyzed to determine whether the receiving entity is permitted to receive data from the requesting entity. The universal reference may be compared to a list of known authorized or unauthorized universal references, or the universal reference can be expanded into a partial listing or a fully-exhaustive listing of the requesting entity's components' universal references, each of which can be assessed to determine whether the requesting entity is trustworthy. Moreover, universal references may be analyzed to determine if the requesting entity includes any mandatory components, such as a particular firewall, a particular version of software, etc. Additionally, the universal reference may be logged.

Operation 1340 determines whether communication between the requesting entity and receiving entity is authorized. If analysis of the universal reference indicates that the requesting entity is trustworthy, then data is received from the requesting entity at operation 1350, and a communication session may be established. Otherwise, the request may be blocked and data is not received at operation 1360.

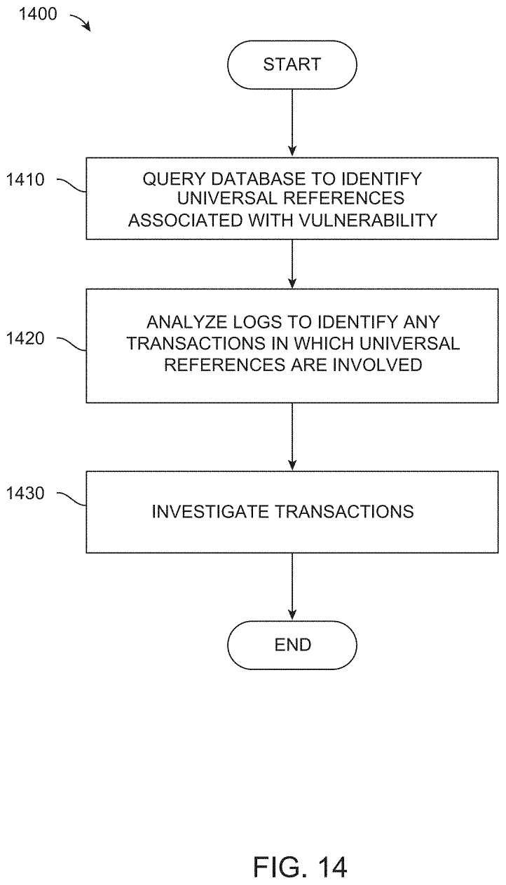

FIG. 14 is a flow chart 1400 depicting a method for performing a forensics task using universal references, in accordance with an example embodiment.

At operation 1410, one or more databases are queried to identify any universal references associated with a vulnerability. A known vulnerability can be associated with particular software and/or hardware components which can be identified by their universal reference(s) (see FIG. 2 and FIG. 3). Accordingly, a database of universal references describing the relationships between any artifact in the artifact hierarchy of any of these particular software and/or hardware components may be queried using one or more universal references of known vulnerable components in order to obtain universal reference matches for any software and/or hardware entities that include one or more of the impacted components.

Logs may be analyzed to identify any transactions in which a universal reference associated with the vulnerability is involved at operation 1420. A log of transactions may include any universal references exchanged by the participants in the transactions, and accordingly, the log may be parsed to identify each transaction.

At operation 1430, the identified transactions may be investigated further. In some embodiments, data that was exchanged by way of the transaction may be verified, authenticated, or re-requested. In some embodiments, any executable packages obtained by way of the transaction may be suspended from execution, deleted, or scanned for malware. In some embodiments, the implicated transactions may be reported to another party, such as a watchdog agency or credit bureau.

Referring to FIG. 15, FIG. 15 illustrates a hardware block diagram of a computing device 1500 that may perform functions associated with operations discussed herein in connection with the techniques depicted in FIGS. 1-14. In various embodiments, a computing device, such as computing device 1500 or any combination of computing devices 1500, may be configured as any entity/entities as discussed for the techniques depicted in connection with FIGS. 1-14 in order to perform operations of the various techniques discussed herein.

In at least one embodiment, the computing device 1500 may include one or more processor(s) 1502, one or more memory element(s) 1504, storage 1506, a bus 1508, one or more network processor unit(s) 1510 interconnected with one or more network input/output (I/O) interface(s) 1512, one or more I/O interface(s) 1514, and control logic 1520. In various embodiments, instructions associated with logic for computing device 1500 can overlap in any manner and are not limited to the specific allocation of instructions and/or operations described herein.

In at least one embodiment, processor(s) 1502 is/are at least one hardware processor configured to execute various tasks, operations and/or functions for computing device 1500 as described herein according to software and/or instructions configured for computing device 1500. Processor(s) 1502 (e.g., a hardware processor) can execute any type of instructions associated with data to achieve the operations detailed herein. In one example, processor(s) 1502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1504 and/or storage 1506 is/are configured to store data, information, software, and/or instructions associated with computing device 1500, and/or logic configured for memory element(s) 1504 and/or storage 1506. For example, any logic described herein (e.g., control logic 1520) can, in various embodiments, be stored for computing device 1500 using any combination of memory element(s) 1504 and/or storage 1506. Note that in some embodiments, storage 1506 can be consolidated with memory element(s) 1504 (or vice versa), or can overlap/exist in any other suitable manner.

In at least one embodiment, bus 1508 can be configured as an interface that enables one or more elements of computing device 1500 to communicate in order to exchange information and/or data. Bus 1508 can be implemented with any architecture designed for passing control, data and/or information between processors, memory elements/storage, peripheral devices, and/or any other hardware and/or software components that may be configured for computing device 1500. In at least one embodiment, bus 1508 may be implemented as a fast kernel-hosted interconnect, potentially using shared memory between processes (e.g., logic), which can enable efficient communication paths between the processes.

In various embodiments, network processor unit(s) 1510 may enable communication between computing device 1500 and other systems, entities, etc., via network I/O interface(s) 1512 (wired and/or wireless) to facilitate operations discussed for various embodiments described herein. In various embodiments, network processor unit(s) 1510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1500 and other systems, entities, etc. to facilitate operations for various embodiments described herein. In various embodiments, network I/O interface(s) 1512 can be configured as one or more Ethernet port(s), Fibre Channel ports, any other I/O port(s), and/or antenna(s)/antenna array(s) now known or hereafter developed. Thus, the network processor unit(s) 1510 and/or network I/O interface(s) 1512 may include suitable interfaces for receiving, transmitting, and/or otherwise communicating data and/or information in a network environment.

I/O interface(s) 1514 allow for input and output of data and/or information with other entities that may be connected to computing device 1500. For example, I/O interface(s) 1514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1520 can include instructions that, when executed, cause processor(s) 1502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1504 and/or storage 1506 can store data, software, code, instructions (e.g., processor instructions), logic, parameters, combinations thereof, and/or the like used for operations described herein. This includes memory element(s) 1504 and/or storage 1506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 1502.11 (e.g., Wi-Fi®/Wi-Fi6®), IEEE 1502.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In some aspects, the techniques described herein relate to a computer-implemented method including: obtaining, by a first entity (e.g., a receiving entity or a requesting entity), a universal reference included in a request of a second entity (e.g., a requesting entity or a receiving entity), wherein the universal reference identifies one or more components of the second entity using additional universal references assigned to each of the one or more components; determining whether the first entity is authorized to receive data from the second entity based on the universal reference; and based on the determining, receiving data from the second entity.

In some aspects, the techniques described herein relate to a computer-implemented method, wherein determining whether the second entity is authorized includes comparing the universal reference to a list of approved universal references.

In some aspects, the techniques described herein relate to a computer-implemented method, wherein determining whether the second entity is authorized includes obtaining a description of the second entity by partially or exhaustively enumerating each additional universal reference of the one or more components and additional sub-components, wherein the description identifies components and sub-components of the second entity.

In some aspects, the techniques described herein relate to a computer-implemented method, wherein an identity of the first entity or the second entity is attested by providing evidence of a cryptographically signed universal reference using software or hardware-based cryptographic mechanisms.

In some aspects, the techniques described herein relate to a computer-implemented method, wherein the second entity obtains the universal reference of the first entity, and wherein the second entity receives data from the first entity in response to determining that the second entity is authorized to receive data based on the universal reference of the first entity.

In some aspects, the techniques described herein relate to a computer-implemented method, wherein the universal reference is stored to a log by one or more of: a logging service, a middleware service, the first entity, and the second entity.

In some aspects, the techniques described herein relate to a computer-implemented method, wherein the universal reference is inserted in a metadata field of the request or a response to the request.

In some aspects, the techniques described herein relate to a computer-implemented method, wherein a remote procedure call session or a representational state transfer communication is established between the second entity and the first entity in response to determining that the first entity is authorized to receive data from the second entity.

In some aspects, the techniques described herein relate to an apparatus including: one or more computer processors; a network interface configured to enable network communications; one or more computer readable storage media; and program instructions stored on the one or more computer readable storage media for execution by at least one of the one or more computer processors, the program instructions including instructions that cause the apparatus to perform operations including: obtaining, by a first entity, a universal reference included in a request of a second entity, wherein the universal reference identifies one or more components of the second entity using additional universal references assigned to each of the one or more components; determining whether the first entity is authorized to receive data from the second entity based on the universal reference; and based on the determining, receiving data from the second entity.

In some aspects, the techniques described herein relate to an apparatus, wherein the instructions to determine whether the second entity is authorized include instructions to compare the universal reference to a list of approved universal references.

In some aspects, the techniques described herein relate to an apparatus, wherein the instructions to determine whether the second entity is authorized include instructions to obtain a description of the second entity by partially or exhaustively enumerating each additional universal reference of the one or more components and additional sub-components, wherein the description identifies components and sub-components of the second entity.

In some aspects, the techniques described herein relate to an apparatus, wherein an identity of the first entity or the second entity is attested by providing evidence of a cryptographically signed universal reference using software or hardware-based cryptographic mechanisms.

In some aspects, the techniques described herein relate to an apparatus, wherein the second entity obtains the universal reference of the first entity, and wherein the second entity receives data from the first entity in response to determining that the second entity is authorized to receive data based on the universal reference of the first entity.

In some aspects, the techniques described herein relate to an apparatus, wherein the universal reference is stored to a log by one or more of: a logging service, a middleware service, the first entity, and the second entity.

In some aspects, the techniques described herein relate to an apparatus, wherein the universal reference is inserted in a metadata field of the request or a response to the request.

In some aspects, the techniques described herein relate to an apparatus, wherein a remote procedure call session or a representational state transfer communication is established between the second entity and the first entity in response to determining that the first entity is authorized to receive data from the second entity.

In some aspects, the techniques described herein relate to one or more non-transitory computer readable storage media collectively having program instructions embodied therewith, the program instructions being executable by a computer to cause the computer to perform operations including: obtaining, by a first entity, a universal reference included in a request of a second entity, wherein the universal reference identifies one or more components of the second entity using additional universal references assigned to each of the one or more components; determining whether the first entity is authorized to receive data from the second entity based on the universal reference; and based on the determining, receiving data from the second entity.

In some aspects, the techniques described herein relate to one or more non-transitory computer readable storage media, wherein the program instructions to determine whether the second entity is authorized further cause the computer to compare the universal reference to a list of approved universal references.

In some aspects, the techniques described herein relate to one or more non-transitory computer readable storage media, wherein the computer instructions to determine whether the second entity is authorized further include instructions to obtain a description of the second entity by partially or exhaustively enumerating each additional universal reference of the one or more components and additional sub-components, wherein the description identifies components and sub-components of the second entity.

In some aspects, the techniques described herein relate to one or more non-transitory computer readable storage media, wherein an identity of the first entity or the second entity is attested by providing evidence of a cryptographically signed universal reference using software or hardware-based cryptographic mechanisms.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining, by a first entity, a universal reference included in a request of a second entity, wherein the universal reference identifies one or more components of the second entity using additional universal references assigned to each of the one or more components;
determining whether the first entity is authorized to receive data from the second entity based on the universal reference; and
based on the determining, receiving data from the second entity.

2. The computer-implemented method of claim 1, wherein determining whether the second entity is authorized comprises comparing the universal reference to a list of approved universal references.

3. The computer-implemented method of claim 1, wherein determining whether the second entity is authorized comprises obtaining a description of the second entity by partially or exhaustively enumerating each additional universal reference of the one or more components and additional sub-components, wherein the description identifies components and sub-components of the second entity.

4. The computer-implemented method of claim 1, wherein an identity of the first entity or the second entity is attested by providing evidence of a cryptographically signed universal reference using software or hardware-based cryptographic mechanisms.

5. The computer-implemented method of claim 1, wherein the second entity obtains the universal reference of the first entity, and wherein the second entity receives data from the first entity in response to determining that the second entity is authorized to receive data based on the universal reference of the first entity.

6. The computer-implemented method of claim 1, wherein the universal reference is stored to a log by one or more of: a logging service, a middleware service, the first entity, and the second entity.

7. The computer-implemented method of claim 1, wherein the universal reference is inserted in a metadata field of the request or a response to the request.

8. The computer-implemented method of claim 1, wherein a remote procedure call session or a representational state transfer communication is established between the second entity and the first entity in response to determining that the first entity is authorized to receive data from the second entity.

9. An apparatus comprising:
one or more computer processors;
a network interface configured to enable network communications;
one or more computer readable storage media; and
program instructions stored on the one or more computer readable storage media for execution by at least one of the one or more computer processors, the program instructions comprising instructions that cause the apparatus to perform operations including:
obtaining, by a first entity, a universal reference included in a request of a second entity, wherein the universal reference identifies one or more components of the second entity using additional universal references assigned to each of the one or more components;
determining whether the first entity is authorized to receive data from the second entity based on the universal reference; and
based on the determining, receiving data from the second entity.

10. The apparatus of claim 9, wherein the instructions to determine whether the second entity is authorized comprise instructions to compare the universal reference to a list of approved universal references.

11. The apparatus of claim 9, wherein the instructions to determine whether the second entity is authorized comprise instructions to obtain a description of the second entity by partially or exhaustively enumerating each additional universal reference of the one or more components and additional sub-components, wherein the description identifies components and sub-components of the second entity.

12. The apparatus of claim 9, wherein an identity of the first entity or the second entity is attested by providing evidence of a cryptographically signed universal reference using software or hardware-based cryptographic mechanisms.

13. The apparatus of claim 9, wherein the second entity obtains the universal reference of the first entity, and wherein the second entity receives data from the first entity in response to determining that the second entity is authorized to receive data based on the universal reference of the first entity.

14. The apparatus of claim 9, wherein the universal reference is stored to a log by one or more of: a logging service, a middleware service, the first entity, and the second entity.

15. The apparatus of claim 9, wherein the universal reference is inserted in a metadata field of the request or a response to the request.

16. The apparatus of claim 9, wherein a remote procedure call session or a representational state transfer communication is established between the second entity and the first entity in response to determining that the first entity is authorized to receive data from the second entity.

17. One or more non-transitory computer readable storage media collectively having program instructions embodied therewith, the program instructions being executable by a computer to cause the computer to perform operations including:
obtaining, by a first entity, a universal reference included in a request of a second entity, wherein the universal reference identifies one or more components of the second entity using additional universal references assigned to each of the one or more components;
determining whether the first entity is authorized to receive data from the second entity based on the universal reference; and
based on the determining, receiving data from the second entity.

18. The one or more non-transitory computer readable storage media of claim 17, wherein the program instructions to determine whether the second entity is authorized further cause the computer to compare the universal reference to a list of approved universal references.

19. The one or more non-transitory computer readable storage media of claim 17, wherein the computer instructions to determine whether the second entity is authorized further comprise instructions to obtain a description of the second entity by partially or exhaustively enumerating each additional universal reference of the one or more components and additional sub-components, wherein the description identifies components and sub-components of the second entity.

20. The one or more non-transitory computer readable storage media of claim 17, wherein an identity of the first entity or the second entity is attested by providing evidence of a cryptographically signed universal reference using software or hardware-based cryptographic mechanisms.
